(19) United States
(12) Patent Application Publication
(10) Pub. No.: US 2005/0268654 A1
(43) Pub. Date: Dec. 8, 2005

(54) Process and device to produce various glass gob masses in the production of glass objects

(75) Inventor: Matthias Haase, Obernkirchen (DE)

Correspondence Address: SYNNESTVEDT & LECHNER, LLP, 2600 ARAMARK TOWER, 1101 MARKET STREET, PHILADELPHIA, PA, 191072950, US

(73) Assignee: Heye International GmbH, Obernkirchen (DE)

(21) Appl. No.: 11/121,227

(22) Filed: May 3, 2005

(30) Foreign Application Priority Data
May 4, 2004 (DE) 10 2004 022 218.5

(51) Int. Cl. C03B 5/26; C03B 5/24

(52) U.S. Cl. 65/29.1; 65/133; 65/29.17; 65/221; 65/328; 65/332; 65/331; 65/164

(57) ABSTRACT

The invention concerns a process or respectively a device for the production of various masses of glass gobs during the manufacture of glass objects, using a glass forming machine (55), where molten liquid glass is flowing out of at least one gob outlet (5″) of a feeder head (3′) of a feeder (4′), and a cyclically operated pair of shears (46) separates the gobs (57). The mass of successive gobs (57) is modified by varying the time interval from shear cut to shear cut. In order to produce a product range of a number of glass objects of different weights, a predetermined time section of the feeder head operation, within which the relevant number of gobs (57) are to be produced, is divided into various time intervals from shear cut to shear cut, depending on the ratio of the desired gob masses. In accordance with the invention, a production of the product range can be achieved in a relatively simple way.

The invention relates to a process and a device according to the preamble of claim 1 or claim 14 respectively.

A feeder with a variable gob weight for container glass is known in practice (“Electronic Feeder Type TSE” from the company J. Walter Co. Maschinen GmbH, 96352 Wilhelmsthal, Germany). With this feeder, which is suitable for the manufacture of a range of hollow glass containers, four different gob weights can be produced in sequence. For example, two plungers are provided in the feeder head. A programmable plunger movement profile can be modified manually by an operator by changing interpolation points via a graphic operator interface. Equally, the stroke position of a plunger can be modified. A manual setting of various, sequential movement profiles of the plunger with the aim of obtaining a certain sequence of various gob weights is very difficult, however, due to the complexity of the relevant input parameters.

A generic process or respectively a generic device are described in US 2003/0172675 A1. Here, a plunger and a related cutting device are individually controlled in order to simultaneously produce gobs of various sizes. A control unit calculates, in a manner not described in more detail, a time window in which a cut by the cutting device is possible. It is explicitly mentioned that in this way cuts are not processed within a machine cycle, but are kept in a waste container. A constant cutting sequence and thus a homogeneous production operation which can be recorded by control technology appears impossible in this manner.

In addition, a generic process and a generic device are known from the document GB 274 370 A. The timing change of the operation of a pair of shears can be effected via a mechanical adjustment of fingers and levers which are actuated by means of a cam drive.

A change to the timing of the operation of a pair of shears is also mentioned in documents U.S. Pat. No. 4,544,397 A and U.S. Pat. No. 3,333,937 A, in order to produce glass gobs of various sizes for the manufacture of glass objects.

It is furthermore known (e.g. from: a special reproduction from the magazine “Siemens-Zeitschrift”, Vol. 51, Issue 9, September 1977, pp. 767-769) that a control device should be fitted to ensure a constant item weight, with which the axial position of a tube of the feeder head is changed, depending on the weight or mass of the formed item. In so doing it is possible to determine the weight of an item, e.g. by weighing. Alternatively, the item weight can also be regulated by measuring the depth of penetration of a plunger during the press-blow process (EP 0 652 854 B1). The height of the glass level inside the tube, and thus the glass volume exiting per feeder cycle or time unit, can be influenced by changing the axial position of the tube. In this way, disturbances like a change in the viscosity of the glass or in the level of the glass melt, for example, can be compensated for. Such a tube regulation circuit is relatively inert owing to the large inner volume of the tube and is therefore unsuitable as a basis for the production of various glass gob masses in the manufacture of a range of glass objects of various weights.

It is the object of the invention to provide a generic process which is relatively simple, for the production of glass gobs of various masses. Furthermore, the invention has the object to provide a generic device that is suitable for the carrying out of this process.

The object relating to the process is solved by the characteristics of claim 1. The glass objects to be manufactured can in particular be hollow glass containers. In one feeder head of one feeder there is at least one gob outlet. Below the gob outlet or outlets, a pair of shears is provided for separating the gobs from one or more strands of liquid glass melt. There can be, for example, two pairs of shear blades which are commonly affixed to a pair of shear arms. The at least one pair of shears is actuated cyclically, in order to produce successive gobs which are fed to the glass forming machine. Due to the fact that the time interval between two successive shear cuts is different over a sequence of a certain number of cuts, the mass of the gobs produced by the individual shear cuts accordingly is also different. The more time expires until the next shear cut, the greater the gob then separated will be. The time interval between two successive shear cuts is also referred to as the shear cycle in the following. It is intended to manufacture a range of goods in the form of a certain number of glass objects of various weights. A certain time section is given for the production by the feeder head of the number of gobs required for that. This time section is divided, from shear cut to shear cut, into various time intervals, depending on the proportion of the desired gob masses.

In doing so, the time section can be divided according to the ratio of the desired gob masses to each other, into various time intervals from shear cut to shear cut. Fundamentally, within the constant time section, the sequence of the various shear cut time intervals and thus the desired ratio of the gob masses or gob weights to each other can be selected at will. With this relatively simple setting of the shear cut timing points, at least an approximation to the desired gob masses is achieved. It is also possible, however, to make provisions for the time section not to be divided according to the ratio of the desired gob masses, but for the ratio of the time intervals to deviate from the ratio of the desired gob masses. For example, during a transition from several successive time intervals of equal length to several successive shorter time intervals, the first of the shorter time intervals could be slightly longer than the subsequent shorter time intervals, whilst the production of gobs of equal weight is provided for, however, through the shorter shear cut time intervals. Such a setting can be arranged in particular by means of a control as described below.

Preferentially, the ratio of the various time intervals from shear cut to shear cut represents a function of the ratio of the desired gob masses. Through this function, various fringe parameters which have an influence on the ratio of the masses of successive gobs, can be considered. In particular the gob diameter, the glass consistency, the production rate and/or the glass temperature, can be fed into the function. If, as described below, a plunger is employed, the type of plunger control can also be entered into the function.

The glass forming machine can be, in particular, an I.S. (individual section) glass forming machine. In this case, the predetermined constant time interval of the feeder head operation, as described above, can be that time interval during which gobs are produced for a complete machine cycle. In this way, a set of a desired product range of glass objects of different weights is produced within each machine cycle. It can also be provided for, however, that during the predetermined constant time interval of the feeder head operation, gobs are produced for several complete machine cycles and that glass objects of the same mass are produced during one single machine cycle; however, during successive machine cycles, different masses are processed.

It can be provided for, in particular, that one or several plungers, which can be moved up and down, are arranged in the feeder head, and influence the outflow of molten liquid glass from the at least one gob outlet. During its upwards movement, at least one of the plungers provides a suction effect, whilst it exerts a pressing effect during its downwards movement. It can be provided for that the at least one plunger is actuated in such a way that the phase position of the shear overlap and of the moment at which the plunger reverts its downward movement to the upward movement, which phase position can be parameterized, i.e. which is adjustable individually for each gob, is kept constant or is variable for the shear cuts within the predetermined time interval. The shear overlap describes the gob cutting, i.e. the process of the cutting off of a gob using the pair of shears. This could be the process of a small overlap of shear blades. The larger the differences in the gob masses, the sooner a variable adjustment of the plunger movement can be required, as described below.

A plunger control usually provides the opportunity to modulate separately the downwards and the upwards movements of the plunger. Therefore, in order to set the phase position in relation to the shear cut, the duration of the plunger movement in the pressing direction can be maintained as constant, whilst the duration of the plunger movement in the direction of suction is adjusted to the relevant time interval of two successive shear cuts. Alternatively, the duration of the plunger movement in the pressing direction can also be adjusted correspondingly, and the duration of the plunger movement in the suction direction can be maintained as constant. Also both partial movements of the plunger can be adjusted in order to set the phase position in relation to the shear cut. Designing the phase position of the plunger movement in relation to the shear cut for the individual shear cycles differently is particularly useful if various masses of gob are produced during various shear cycles, because in this way the cutting location of the shear in a glass strand exiting from the gob outlet can be optimized. If a given time section of the feeder head operation, e.g. the time section of a machine cycle, is provided, and if it is cyclically repeated, any shear cycles that are analogous will, however, usually show the same phase position relative to the shear cut within the successive time sections.

Another possibility to adjust the plunger movement to the chronological sequence of the shear cuts can be carried out by adjusting a standstill duration of the plunger in its top reversal position.

Preferably, the phase position of the movement of a gob distributor is adjusted to the various shear cut time intervals in order to ensure that the gob distributor is standing still sufficiently long enough for a gob to pass through.

Preferably, a control of the gob masses is carried out. This is done by comparing a mass-related actual value to a mass-related set value. A difference between the actual value and the scheduled value is minimized by adjusting the shear cut time intervals. The harmonization of the actual values to the scheduled values is preferably carried out gradually. When controlling the gob masses, at the beginning of an adjustment of the procedural parameters one can assume, for simplicity's sake, a linear relationship between the shear cut time intervals and the gob masses produced, with an appropriate correction now being performed using the control. Of course, for any future process course, the data of a tuned system can be used as a basis.

The actual values are preferably captured automatically by appropriate recording systems, or even manually. Besides the direct value of the mass, other quantities which are in direct relation to the mass, can be determined, too, for example the depth of penetration of a plunger into a forming tool during the press-blow process. The greater the maximum depth of penetration of the plunger is, the smaller is the gob mass that has entered a blank.

Preferably, an axial adjustment of the tube, also called choke tube, is also carried out during the control of the gob masses. If a shear cut time interval is changed, this will always have repercussions on the remaining shear cut time intervals, as the available overall duration, within which the moment of the shear cuts are moving, is constant. By including the axial adjustment of the tube in the control, these repercussions can be counteracted.

In order to achieve the desired mass for all the gobs to be produced within the predetermined time section, it may be necessary to adjust the tube axially or vertically in such a way that the mass of all gobs are raised or lowered within that time section. This control mechanism will be exemplified below:

An I.S. glass forming machine with ten sections shall work with a gob weight of 300 g for the first five sections, at a production rate of 120 gobs per minute. The next five sections are to process gobs with a weight that is 5% smaller. The ratio of the scheduled gob weight values will produce five shear cut time intervals (sections 1-5) of 512.82 ms, followed by five shear cut intervals (sections 6-10) of 487.18 ms. A check, by recording the actual gob weight values, shows that the first five sections are correctly loaded with 300 g, the gob weight of the five following sections, however, is short by 10 g. The control will now change the ratio of the shear cut time intervals to, for example, five shear cut time intervals (sections 1-5) of 507.82 ms, followed by five shear cut time intervals (sections 6-10) of 492.18 ms. The consequence of this is that the gobs in sections 1-5 are slightly lighter and the gobs of sections 6-10 are slightly heavier. Thus the weight of all ten gobs to be produced is slightly below their respective scheduled value. In accordance with this tendency, the axial adjustment of the tube is now actuated via a drive of the tube, in order to increase slightly the gob weight altogether for all gobs that are to be produced. The cyclical pass of this adjustment structure will ensure that the desired ratio of the gob weights is adjusted.

The movement profile of the plunger or of the respective plunger holder, too, exerts an influence on the mass or contour of a gob that has been given out by the gob outlet. The velocity, for example, with which the plunger reverses from its lower end position is relevant. Any longer stillstand duration of the plunger, or plunger holder, in its lower end position produces a smaller item weight, because the plunger, in its lower end position, is usually partially blocking the cross section of the glass outlet that is effective for the glass exiting.

Therefore it can also be provided to carry out a change of the movement or of the movement profile of the at least one plunger, in addition to, or in place of, the axial adjustment of the tube, in order to increase or decrease the gob weight altogether for all gobs that are to be produced. In particular, a change of the plunger velocity in the upwards or downwards movement can be carried out. This can be effected by an appropriate control of the plunger holder.

It may be necessary, in particular during a tuning phase of a control, to adjust later the actuation moment of some sections. This can be done through a manual input in a machine control, or preferably automatically, via e.g. a standard communications link through a shear control unit.

The object relating to the device is solved through the characteristics of claim 14. The device for the production of various glass gob masses during the manufacture of glass objects, in particular of hollow glass containers, comprises a feeder head of a feeder. Furthermore, the device has at least one gob outlet, comprising a shear arranged below. A drive control unit is provided in order to operate the shear cyclically. By arranging the drive control unit in such a way that the time interval between each two successive shear cuts can be varied, a change to the mass of successive gobs is possible. The device is provided for the manufacture of a range of a number of various glass objects. In order to produce the gobs of different masses required for the various glass objects, a predetermined time section of the feeder head operation is stored in the drive control unit. The number of gobs required for the range of goods to be manufactured is produced within this time section. Furthermore, a function of the ratio of the desired gob masses is stored in the drive control unit. This function determines the ratio of various time intervals from shear cut to shear cut. The time intervals divide the named time section.

In the feeder head, at least one plunger, moveable up and down, can be arranged in order to influence the flowing-out of glass from the at least one gob outlet.

Preferred embodiments of the device are stated in the claims 15 to 24. In particular, if, as described, a plunger is used, the type of plunger control can be incorporated in the function as per claim 15.

The advantages which are described above in connection with the process in accordance with the present invention apply accordingly to the device in accordance with the present invention.

The invention is explained in more detail hereunder with reference to exemplified embodiments and the figures, in which

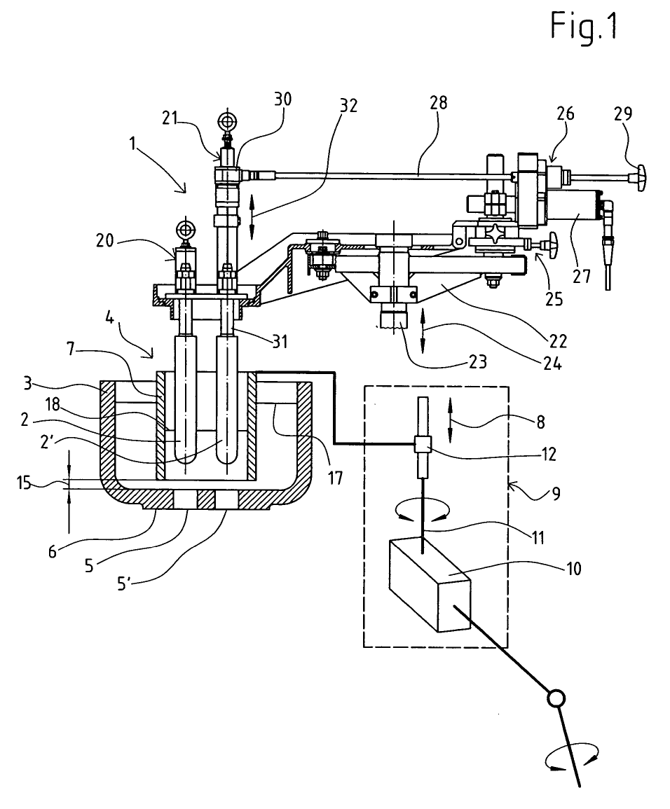

FIG. 1 shows schematically a partial view of a device for the production of various glass gob masses during the manufacture of hollow glass containers using an I.S. glass forming machine.

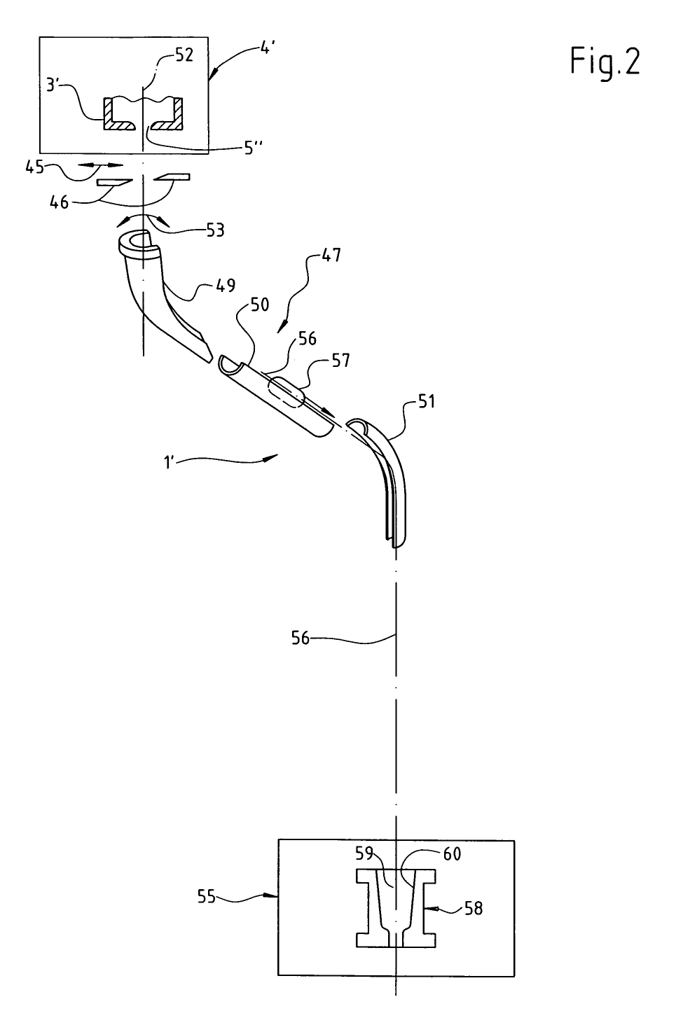

FIG. 2 shows schematically a different partial view of a device very similar to the device according to FIG. 1, comprising only one gob outlet.

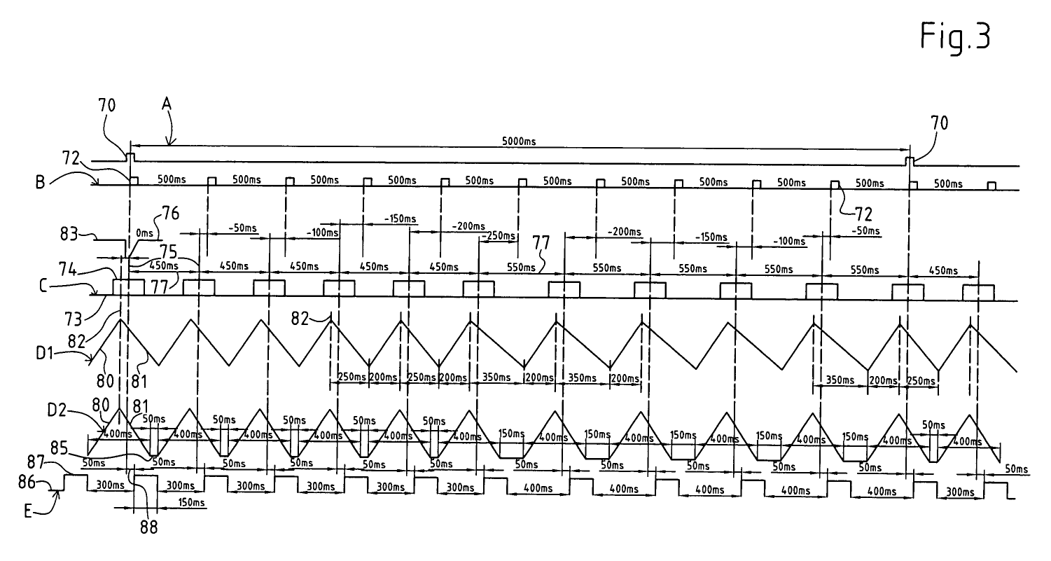

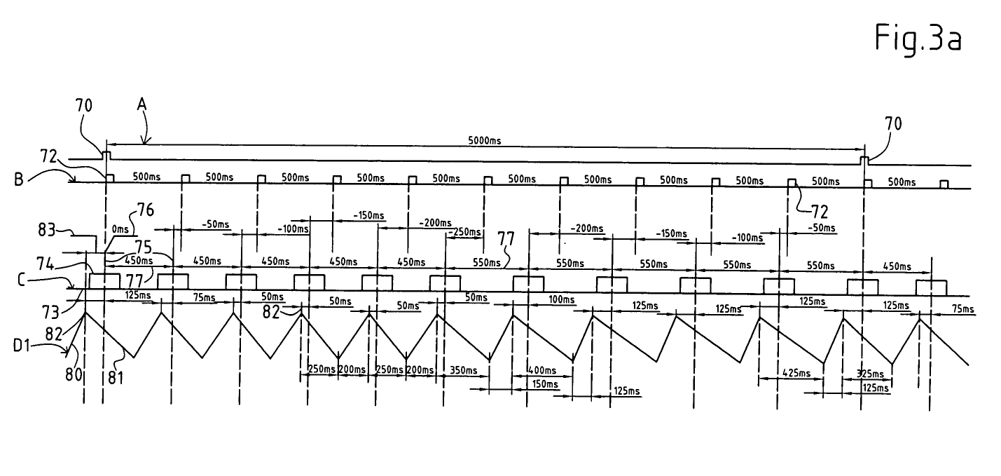

FIG. 3 shows a typical time lapse in principle during the production of gobs of various masses for the processing in an I.S. glass forming machine.

FIG. 3a shows a further typical time lapse in principle during the production of gobs of various masses for the processing in an I.S. glass forming machine.

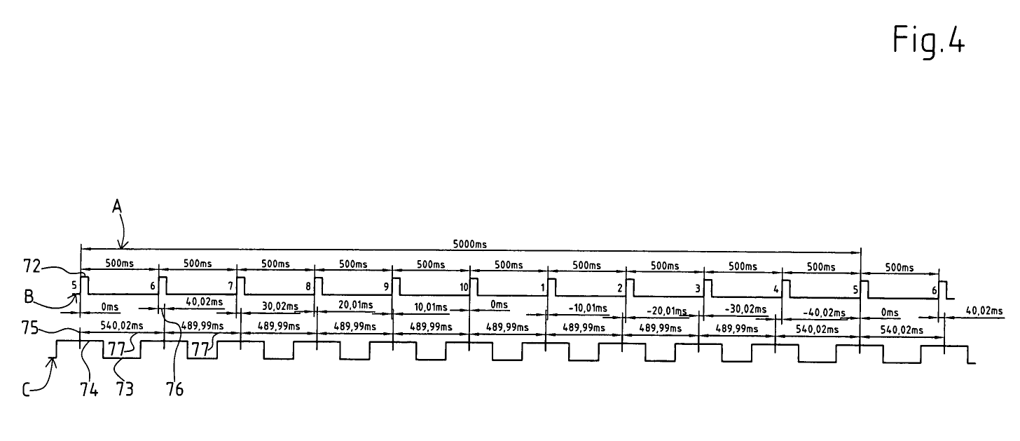

FIG. 4 shows an example of a concrete time lapse during the production of gobs of various masses for the processing in an I.S. glass forming machine.

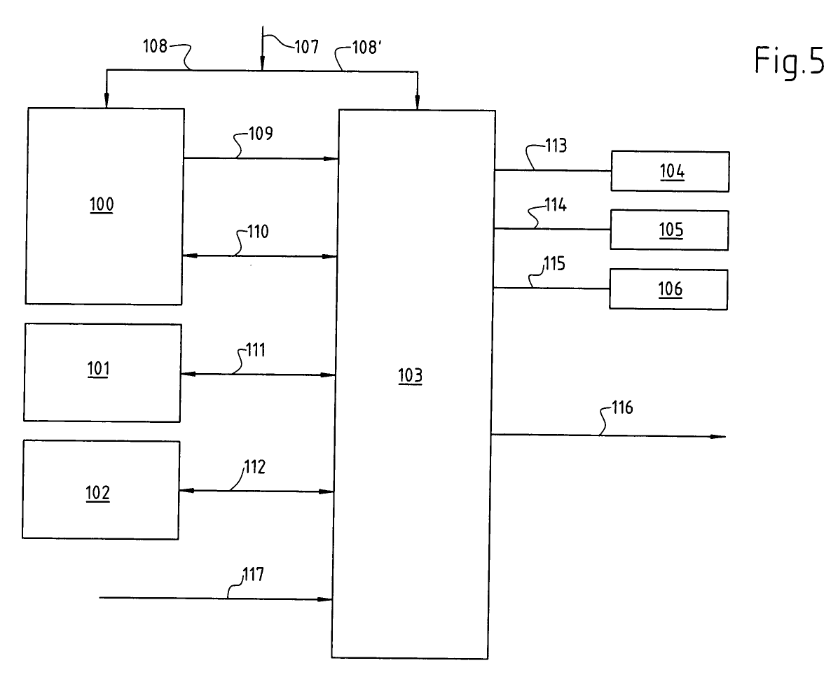

FIG. 5 shows a block diagram to explain an interconnection of device components during the production of various glass gob masses.

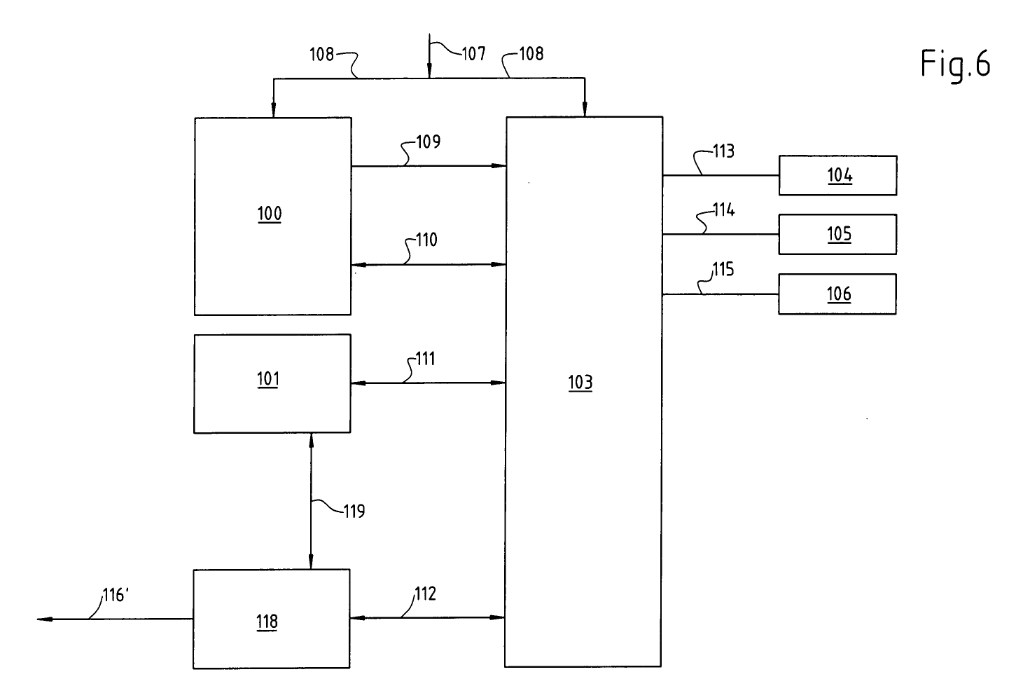

FIG. 6 shows a block diagram to explain a different interconnection of device components during the production of various glass gob masses.

The device for the production of various glass gob masses according to FIG. 1 is designated 1. Device 1 comprises two plungers 2 and 2′. The plungers 2, 2′ are arranged in a feeder head 3 of a feeder 4. The feeder head 3 comprises a dual gob outlet which is formed by two through-holes 5 and 5′ in a orifice ring 6. Furthermore, the feeder head 3 comprises a tube 7, which surrounds the two plungers 2 and 2′. The tube 7 can be modified in a known fashion in its axial position, which serves as a manipulated variable, in accordance with the double arrow 8. A drive 9 of the tube 7 is shown schematically in FIG. 1 and only partially drawn. For adjusting the axial position of tube 7, a motor, not shown, is provided, driving a spindle 11 via a miter gear mechanism 10. The spindle 11 operates in conjunction with a spindle nut 12 connected to tube 7. Furthermore, a mechanism (not shown) can be provided in order to be able to adjust horizontally the tube 7 for a symmetrical arrangement around the dual gob outlet 5, 5′. A gap 15 is adjusted between a lower end of tube 7 and the orifice ring 6, by means of the vertical adjustment according to double arrow 8.

Molten liquid glass is in the feeder head 3. The glass level outside tube 7 is designated 17, whilst the glass level inside the tube is designated 18. The glass level 18 depends on the glass level 17 and on the size of gap 15. The glass level 18 finally determines the volume of glass exiting the holes 5, 5′ per time unit or per feeder cycle. By vertically adjusting tube 7 as per double arrow 8, therefore, for example a change of glass level 17, or a change to the viscosity of the molten liquid glass can be balanced over a time period which is relatively long compared with the duration of a feeder cycle. In particular, the vertical adjustment of the tube can also be carried out, in order to raise or lower all gob weights, in accordance with the present invention as described above, in order to control the various gob masses.

The plungers 2, 2′ are both fastened to a plunger holder 22 by means of fastening means 20 or 21. The plunger holder 22 is fastened to a carrier column 23 which can be vertically moved up and down, as indicated by double arrow 24. The drive mechanism, not shown, for the carrier column 23 could, for example, be the drive mechanism according to DE 203 16 501 U1. The plunger holder 22 comprises means 25 for the fundamental horizontal adjustment.

Whilst the height of plunger 2 relative to plunger holder 22 is fixed, the height of plunger 2′ relative to plunger holder 22 can be changed by means of a height adjustment device 26. The height adjustment device 26 comprises a motor gearing unit 27 driving a shaft 28. A hand wheel 29 enables shaft 28 to be turned by hand. Shaft 28 actuates a guide element 31 of the fastening means 21 via a worm gear 30, in order to move plunger 2′ in accordance with double arrow 32.

Like features are designated with like reference signs in all figures.

FIG. 2 shows schematically a similar device 1′ with a feeder head 3′ of a feeder 4′. The feeder head 3′ comprises only one 5″ through-hole as a gob outlet. A strand of molten liquid glass (not shown) exits from the gob outlet 5″, from which gobs are cut off cyclically by a pair of shears 46 moving in the direction of the double arrow.

Below the pair of shears 46 there is a trough system 47. This trough system 47 has a scoop trough 49 of a gob distributor, a long trough 50 and a final trough 51 which is bent down. The scoop trough 49 can be swiveled in a known manner, which is not further detailed here, around a longitudinal axis 52 of the gob outlet 5″, as indicated by the double arrow 53. The scoop trough 49 therefore catches all gobs separated by the pair of shear 46 and guides them, according to its swivel position, successively to the remaining trough system 47. The trough system 47 comprises a number of long troughs 50 and final troughs 51, in accordance with the number of sections of an I.S. glass forming machine 55, of which respectively only one is shown in FIG. 2 for the sake of clarity.

The final trough 51 is bent down in such a manner that a gob exits vertically from final trough 51. The trough system 47 creates a gob path 56 as exemplified for the gob 57.

The gobs 57 on their path 56 reach in a mould 58, e.g. a blank of the glass forming machine 55. A longitudinal axis 59 of a mould recess 60 of mould 58 coincides with the final section of gob path 56. The mould 58 is exemplary for a series of moulds of the I.S. glass forming machine 55.

FIG. 3 shows a timing example of an I.S. glass forming machine with ten sections and 120 cuts per minute, where a range of hollow glass containers are to be manufactured, where initially five light and subsequently five heavy gobs are to be produced.

A machine cycle A, an external clock signal sequence B, a shear cycle sequence C, a first variant of a plunger cycle sequence D1, a second variant of a plunger cycle sequence D2 and a movement of the scoop trough E are applied over a horizontal axis.

The machine cycle A runs for 5000 ms from a zero reference signal 70 to another zero reference signal 70. The shear cycle sequence C and the plunger cycle sequences D1, D2, in essence run for the duration of the machine cycle A. The external clock signal sequence B has a series of external clock signals 72. (The first and last shown clock signal 72 of the machine cycle A are designated.)

The shear cycle sequence C comprises idle periods 73 and movement periods 74 of a shear. The moments of the shear overlap are designated 75 and in this embodiment are in the center of the movement periods 74. The chronologically last shear overlap 75 of the machine cycle A does not comprise any delay in relation to the following external clock signal 72, concerning the control functionality, and coincides with the start of this clock signal. The further nine shear overlaps 75 of machine cycle A, however, are chronologically before the following external clock signal concerning the control functionality, i.e. in relation to this, they show a negative delay in the range of −50 ms to −250 ms. The delay periods are each shown at 76. The first five time intervals 77 of shear cut 74 to shear cut 74 are 450 ms, and the five next time intervals 77 of machine cycle A are 550 ms. The time intervals 77 are also called shear cycle.

D1 shows the cyclical course of the movement of a plunger, where the pressing downwards movements of the plunger (rising edges of D1) are designated with 80 and the suction upwards movements of the plunger (trailing edges of D1) are designated with 81. The moments at which the plunger is at its lower reversal position are indicated with dashed lines 82 for some plunger movements. A chronological gap 83 between the reversal of movement 82 of the plunger and the moment of shear overlap 75 indicates the phase position from the shear overlap 75 to the plunger. This phase position 83 can be parameterized, i.e., it can be adjusted for each time interval 77 from shear overlap 75 to shear overlap 75. In FIG. 3, it is constant across the total machine cycle A. For all shear cuts 74 within the machine cycle A, the point of time 82 of the reversal of movement of the plunger lies slightly before the shear overlap 75.

The adjustment of the phase position 83 is achieved in the variant D1 of the plunger cycle, by varying the duration of the upwards movement 81 of the plunger in accordance with the various time intervals 77 from shear overlap 75 to shear overlap 75. Whilst the upwards movement of the plunger lasts for 250 ms during the first five shear cuts 74, it is increased to 350 ms during the following five shear cuts 74. The duration of the downwards movement 80 of the plunger, however, remains constant at 200 ms across the total machine cycle A.

In the variant D2 of the plunger movement, however, the desired phase position 83 between the moments of the shear overlaps 75 and the plunger is achieved by modifying a standstill duration 85 of the plunger in its top reversal position. The standstill duration 85 for the first five shear cuts 74 is 50 ms and for the next five shear cuts 74 it is 150 ms. The downwards and upwards movements of the plunger, designated 80 and 81 respectively also in D2, remain constant, however, across the total machine cycle A and are chronologically symmetrical to each other.

The movement E of the scoop trough shows standstill periods 86 and movement periods 87. The movement periods 87 of the scoop trough begin with a delay time 88 of 50 ms after the moment 75 of the shear overlap. The standstill period 86 of the scoop trough increases from 300 ms during the first five shear cuts 74 to 400 ms during the next five shear cuts 74 of the machine cycle A.

FIG. 3a shows an example of a time lapse where the phase position 83 for the individual shear cycles 77 is variable. Apart from the differences in the phase position 83, the timing in the example corresponds with the timing example of FIG. 3, where the movement E of the scoop trough is not illustrated and no second variant D2 of the plunger movement is shown. According to FIG. 3a, also five light and five heavy gobs are to be produced within a machine cycle A, and it is pointed out for clarity's sake that the first shear cut 74 illustrated in FIG. 3a is still a part of the previous machine cycle. Although the gobs of the first five shear cuts 74 of machine cycle A, which are the light gobs, should all be of equal weight, the phase position 83 for these five shear cuts 74 is not constant. In fact, the time interval 83 between plunger movement reversal 82 and the moment of shear overlap 75 for the first light gob is 75 ms, and for the subsequent light gobs it is 50 ms. The reason for this is that the conditions during the first light gob are still being influenced by the previous heavy gob. This influence is being compensated for by the phase position 83 which is adjusted accordingly, in order to ensure that the shear cut 74 always occurs at a neck of the glass strand that is exiting the gob outlet. The same applies correspondingly for the transition from the fifth to the sixth shear cut 74 of the machine cycle A shown. The sixth shear cut 74 does indeed produce a heavy gob, the phase position 83, however, is only 100 ms due to the previous light gob. During the seventh to the tenth shear cut 74, it is, however, 125 ms. The setting of the phase position 83 in this timing example is achieved by the fact that not only the duration of the upwards movement 81 of the plunger, but also the duration of the downwards movement 80 of the plunger are being varied.

In FIG. 4, the first six external clock signals are designated 5 to 10 and the further four external clock signals are designated 1 to 4. In this shear cycle sequence C, it is provided that the first and last drops of machine cycle A, i.e. two successive gobs each time, respectively viewed across several machine cycles, are heavier gobs than the following eight gobs. In this embodiment, a factor which considers device-specific data like gob diameter, production rate, glass temperature etc., has been used in order to achieve a pre-adjustment of the shear movement which is as close as possible to the conditions found in the compensated status. A change to a plunger movement in order to achieve the phase position between the moments of shear overlap 75 and the moments of movement reversal of the plunger in its lower position, is not provided for in this embodiment.

The time courses of FIGS. 3, 3a and 4 could each be applied in the devices 1, 1′, in accordance with FIGS. 1 and 2.

FIG. 5 shows a machine control unit 100 for an I.S. glass forming machine 55, a parameterizing unit 101, an actual value recording device 102, a drive control unit 103 as well as a plunger holder or plunger drive 104, a shear drive 105 and a gob distributor drive 106. An external clock signal 72 is fed via data lines 107, 108 and 108′ to the machine control unit 100 and the drive control unit 103. The machine control unit 100 sends a zero reference signal 70 via a data line 109 to the drive control unit 103. Furthermore, there is a standard communications link 110, 111 and 112 between the drive control unit 103 and the machine control unit 100, the parameterizing unit 101 and the actual value recording device 102 respectively. The drive control unit 103 is linked via control lines 113, 114 and 115 to the plunger holder drive 104, the shear drive 105 and the gob distributor drive 106 respectively.

In addition, a control line 116 from the drive control unit 103 to a drive 9 of a tube 7 is provided.

The parameterizing unit 101 can, for example, be an operator terminal and/or a central parameterizing system. Input of the desired gob weights and the parameterizing of the control are carried out via the parameterizing unit 101. The mass-related actual values are automatically captured via the actual value recording device 102, i.e. the recording of the position of the plunger, for example.

The drive control unit 103 is to carry out the control of the gob masses or weights, by varying the time intervals 77 from shear cut to shear cut in conjunction with a variation of the plunger movement in the direction of suction and/or pressing, as well as an appropriate control of the axial position of the tube 7 or respectively its drive 9, via the control line 116.

A manual data input into the control unit 103 can be carried out via a data line 117. Such a manual input of data could also be carried out via the parameterizing unit 101.

In accordance with FIG. 6, and as an alternative to the control process according to FIG. 5, which is only effected through the drive control unit 103, the tube 7 can also be adjusted by a different control system, for example, a process control unit 118 which records the actual mass-related values, and which control system can be parameterized in such a way that only the weights of individual gobs or groups of gobs of the same weight will be used to determine the actual values. Thus, in the above described example explaining the regulating mechanism, the first five gobs could be weight-regulated with the aid of an already existing process control unit 118 by adjusting the tube 7, and for this purpose the process control unit 118 is connected via a control line 116′ to the tube drive 9. In order for this regulating mechanism to be able to work in conjunction with the regulating mechanism deriving from the drive control unit 103 which is used to alter the shear cycles, the process control unit 118 and the drive control unit 103 are linked via a standard communications link 112. Furthermore, according to FIG. 6, another standard communications link 119 is provided between the parameterizing unit 101 and the process control unit 118. A device operator stipulates via the parameterizing unit 101, which gob weight he desires in what sections, and which sections will be used for the determination of the actual values for the regulation. In the example above, described to explain the regulating mechanism, the process control unit 118 would ensure that the weight of the gobs for the sections 1-5 would take the set value by adjusting the vertical position of the tube 7, and that the weight of the gobs for the sections 6-10 would be controlled by adjusting the shear cycle duration.

According to both FIG. 5 and FIG. 6, a clock signal generated by the drive control unit 103, instead of the external clock signal 72, could also be provided, which would also be made available to other device components which might require it.

1. Process for the production of various masses of glass gobs during the manufacture of glass objects using a glass forming machine (55), where molten liquid glass flows from at least one gob outlet (5, 5′; 5″) of a feeder head (3; 3′) of a feeder (4; 4′) and a cyclically operated pair of shears (46) separate the gobs (57),
whereby the mass of successive gobs (57) is altered by varying the time interval (77) from shear cut (74) to shear cut (74),
characterized in that for the manufacture of a range of a number of glass objects of varying weights, a predetermined time section (A) of the feeder head operation, within which the relevant number of gobs (57) is to be produced, is divided into different time intervals (77) from shear cut (74) to shear cut (74), depending on the ratio of the desired gob masses.

2. Process according to claim 1,
characterized in that the ratio of the different time intervals (77) from shear cut (74) to shear cut (74) is a function of the ratio of the desired gob masses.

3. Process according to claim 2,
characterized in that one or several parameters from the group of gob diameter, glass consistency, production rate and glass temperature are input into the function.

4. Process according to claim 1,
characterized in that the glass forming machine is an I.S. (Individual Section) glass forming machine (55).

5. Process according to claim 4,
characterized in that during the predetermined time section (A) of the feeder head operation, gobs (57) are produced for a complete machine cycle (A) or several complete machine cycles (A).

6. Process according to claim 1,
characterized in that at least one plunger (2, 2′), which can be moved up and down, is arranged in the feeder head (3, 3′) in order to influence the outflow of the glass, and the at least one plunger (2, 2′) is controlled such that for every shear cut (74) within the predetermined time section (A), a desired phase position (83) of the shear overlap (75) and of the moment (82) of the reversal of the plunger movement from pressing to suction is obtained.

7. Process according to claim 6,
characterized in that the duration of the movement (80) of the plunger (2, 2′) in the pressing direction is constant, whilst the duration of the movement (81) of the plunger (2, 2′) in the direction of suction is adjusted to the relevant time interval (77) of two successive shear cuts (74), or vice versa.

8. Process according to claim 6,
characterized in that both the duration of the movement (80) of the plunger (2, 2′) in the pressing direction as well as the duration of the movement (81) of the plunger (2, 2′) in the direction of suction are adjusted to the relevant time interval (77) of two successive shear cuts (74).

9. Process according to claim 6,
characterized in that a duration of standstill (85) of the plunger (2, 2′) during its reversal of movement from suction to pressing is adjusted to the relevant time interval (77) of two successive shear cuts (74).

10. Process according to claim 1,
characterized in that a phase position (88) of the movement (E) of a gob distributor (49) is adjusted to the different shear cut time intervals (77).

11. Process according to claim 1,
characterized in that a control of the gob masses is carried out by comparing a mass-related actual value with a mass-related set value and by adjusting the shear cut time intervals (77) in order to minimize the difference between actual and set values.

12. Process according to claim 11,
characterized in that additionally an axial adjustment of a tube (7) is carried out within the control.

13. Process according to claim 11,
characterized in that within the control, additionally an alteration to the movement of the plunger (2, 2′) is carried out, e.g. a change to the velocity of the plunger (2, 2′) in the downwards (80) and/or upwards (81) movement.

14. Device (1, 1′) for the production of various masses of glass gobs during the manufacture of glass objects using a glass forming machine (55), comprising a feeder head (3; 3′) of a feeder (4; 4′), whereby the feeder head (3; 3′) comprises at least one gob outlet (5, 5′; 5″) for the outflow of liquid molten glass, and a pair of shears (46) for the separation of the gobs (57), which can be actuated cyclically by a drive control unit (103),
whereby the drive control unit (103) is designed for the variation of the time interval (77) from shear cut (74) to shear cut (74), in order to alter the mass of successive gobs (57), and
the device (1;1′) is provided for the manufacture of a range of a number of different glass objects,
characterized in that stored within the drive control unit (103) are a time section (A) of the feeder head operation, within which the relevant number of gobs (57) is produced, and furthermore a function of the ratio of the desired gob masses which determines the ratio of different time intervals (77) from shear cut (74) to shear cut (74), into which the predetermined time section (A) is to be divided.

15. Device according to claim 14,
characterized in that one or several parameters from the group of gob diameter, glass consistency, production rate and glass temperature are considered in the function.

16. Device according to claim 14,
characterized in that the glass forming machine is an I.S. (Individual Section) glass forming machine (55).

17. Device according to claim 16,
characterized in that the predetermined time section (A) is chosen such that gobs are produced for a complete machine cycle (A) or for several complete machine cycles (A) during this time section (A).

18. Device according to claim 14,
characterized in that at least one plunger (2, 2′), which can be moved up and down, is arranged within the feeder head (3, 3′), in order to influence the outflow of the glass, and
the drive control unit (103) being designed such that it controls a drive unit (104) of the plunger (2, 2′) in such a way that for every shear cut (74) within the predetermined time section (A) a desired phase position (83) of the shear overlap (75) and of the moment (82) of the plunger's movement reversal from pressing to suction is obtained.

19. Device according to claim 18,
characterized in that the drive control unit (103) is designed so that it adjusts the movement duration (81) of the plunger (2, 2′) in the direction of suction and/or the movement duration (80) of the plunger (2, 2′) in the pressing direction and/or a duration of standstill (85) of the plunger (2, 2′) during its movement reversal from suction to pressing, to the relevant time interval (77) of two successive shear cuts (74).

20. Device according to claim 14,
characterized in that the drive control unit (103) is designed to adjust a phase position (88) of the movement of a gob distributor (49) to the different shear cut time intervals (77).

21. Device according to claim 14,
characterized in that the drive control unit (103) is designed to carry out a control of the gob masses, by a set mass-related value being stored in the drive control unit (103), which is compared with an actual mass-related value which is recorded by an actual-value-recording unit (102) and fed via a data line (112) to the drive control unit (103), with the drive control unit (103) adjusting the shear cut time intervals (77) in order to minimize the difference between said actual and set values.

22. Device according to claim 21,
characterized in that the drive control unit (103) for the control of the gob masses additionally is designed to control a drive unit (9) of a tube (7) for the tube's axial adjustment.

23. Device according to claim 21,
characterized in that a process control unit (118) is designed to control a drive unit (9) of a tube (7) for the tube's axial adjustment for the purpose of the control of the gob masses and that there is a communications link (112) between the drive control unit (103) and the process control unit (118).

24. Device according to claim 21,
characterized in that the drive control unit (103) additionally is designed such that it alters movement parameters of the plunger (2, 2′) in such a way that the gob mass is altered.
